(19) United States
(12) Patent Application Publication
(10) Pub. No.: US 2022/0239194 A1
(43) Pub. Date: Jul. 28, 2022

(54) PORTABLE ELECTRICITY GENERATOR POWERED BY MUSCLE ENERGY, GRAVITATIONAL ENERGY, OR BOTH INCORPORATING FAST-CHARGING TECHNOLOGY

(71) Applicant: Gregory Flanders Rucks, Hamilton, MT (US)

(72) Inventor: Gregory Flanders Rucks, Hamilton, MT (US)

(21) Appl. No.: 17/157,593

(22) Filed: Jan. 25, 2021

(51) Int. Cl. H02K 7/18; H02K 7/116; F03G 5/06; H02K 5/22

(52) U.S. Cl. CPC H02K 7/1853; H02K 7/116; H02J 7/32; H02K 5/225; F03G 5/06

(57) ABSTRACT

A portable, self-contained rotary generator able to fast-charge electronic devices via a universal serial bus (USB) interface. Human muscle energy, gravitational energy, or a combination of both can be delivered to the generator by a crank whereby input motion is rotary or a wheel whereby input motion is linear. Input motion and its associated energy are modified by a gear ratio connected to a generator which produces electrical power. Power electronics convert the electrical power and deliver it to a connected electric device in accordance with USB fast-charging standards such as USB Power Delivery (USB-PD) or Qualcomm Quick Charge (QC). A removable means of securing the generator to solid objects alleviates the need for two-handed operation, enables embodiments harnessing gravitational energy, and increases the potential power output of all embodiments of the generator.

### CROSS-REFERENCE TO RELATED APPLICATIONS

This application claims the benefit of provisional patent application Ser. No. 62/965,811, filed Jan. 25, 2020 by the present inventor, which is incorporated by reference in its entirety.

### FEDERALLY-SPONSORED RESEARCH

Not Applicable

### SEQUENCE LISTING OR PROGRAM

Not Applicable

### BACKGROUND

### Technical Field

The present invention relates to electrical generators, and more specifically to generators using human muscle energy or gravitational potential energy to charge battery-powered electronic devices via universal serial bus (USB).

### Prior Art

The first electrical generator was created in 1831 by Michael Faraday and was powered by human muscle energy. Generators powered by the action of gravity on water were first created in the 1880s. Innovation to better harness these two sources of electricity, human muscles and gravity, has continued, but each has progressed along its own separate pathway. Recent technological developments have created opportunity not only for accelerated progress along the separate pathways of human- and gravity-powered electricity, but for the pathways to be combined.

The following is a tabulation of relevant prior art

U.S. Patents

| Patent Number | Kind Code | Issue Date | Assignee |
|---|---|---|---|
| 8,988,038 | B2 | Mar. 24, 2015 | Wilson |
| 10,263,441 | B1 | Apr. 16, 2019 | Asian |

U.S. Patent Publication Applications

| Publication Nr. | Kind Code | Publ. Date | Applicant |
|---|---|---|---|
| 349,607 | A1 | Dec. 3, 2015 | Nelson |

With the emergence of USB fast-charging standards such as USB power delivery (USB-PD), introduced in 2012, and Qualcomm QuickCharge (QC), introduced in 2013, charging devices via USB at up to 100 watts has become possible.

Despite these dramatic improvements to charging standards, which have in turn led to the development of higher power wall and car chargers for portable electronic devices now making their way into the market, human- and gravity-powered electricity generators have lagged behind. Of the gravity-powered generators in the prior art, none provide electronic device charging functionality via a USB interface. Of the human-powered generators in the prior art, some do provide electronic device charging functionality via a USB interface (U.S. Pat. Nos. 8,988,038, 10,263,441, and 349,607). However, none of these incorporate the power electronics enabling two-way device communication and power negotiation that USB fast-charging standards require. As a result, the maximum power at which they can charge USB devices, including smartphones, is less than 10 watts-less than half the charge rate at which smartphones are able to charge. All of the prior art in question was developed after the introduction of USB fast-charging standards. Higher power of course means faster charging, and in situations to which a hand-cranked USB charger is most applicable, speed is everything. The last thing a person with a dead phone in a power outage or emergency situation is in a position to do is crank for minutes on end to get their phone to power on, then have it die again because they can't deliver enough power to keep it running.

The shortcoming of these hand-cranked USB chargers is not simply a failure to specify the power electronics allowing them to comply with USB fast-charging standards. To illustrate this point, imagine for a moment that we simply incorporated the updated power electronics associated with USB fast-charging to the hand-cranked USB chargers in the prior art. They would still have difficulty generating more than 10 watts because they do not incorporate a means of securing the generator to a solid object during operation so that it keeps still. In my experience, using one hand to crank and the other to hold the generator or hold it still, as the prior art requires, becomes infeasible with the cranking power associated with USB fast-charging. This operational requirement of the prior art also means that users are unable to crank with one hand while using the other for another task such as operating the electronic device being charged. This scenario becomes particularly likely if the device has just been powered back on after having died, is being used, and requires more power to stay on. Smartphones, laptops, and GPS units are among the devices to which this scenario would apply.

I have been obliged to treat the prior art of gravity-powered generators separately from human-powered generators. This is illustrative of another shortcoming of the prior art: a single electricity generator powered by either human muscle energy or gravity, or both at the same time, has not been described in the prior art. Gravity-powered generators tend to use drive mechanisms that convert linear motion to rotary motion that drives the generator, while human-powered generators tend to use rotary input motion directly. Neglecting to accommodate these two types of drive mechanism is among the reasons the prior art has neither diversified its means of harnessing energy from human muscles or gravity, nor been able to combine them.

### SUMMARY

The present invention is a portable power source capable of charging battery-powered electronic devices in compliance with USB fast-charging standards such as USB Power Delivery and Qualcomm Quickcharge. It does this by converting human muscle energy, gravitational potential energy, or a combination of both to electrical power. Human muscle energy or gravitational energy is delivered by a crank arm or a wheel coupled to a first rotational element.

Both the crank arm and wheel removably attach to the first rotational element via a collar attached to the first rotational element. This allows a user to choose between the crank arm and wheel as the means of operating the portable power source. It also allows the portable power source to be compactly stored and helps prevent damage during transport.

When human muscle energy effects rotation of the crank arm, the first rotational element rotates. When human muscle energy, gravitational energy, or a combination of both effects rotation of the wheel, the first rotational element rotates. Rotation of the crank arm is accomplished by directly rotating the end of the crank arm. Rotation of the wheel is accomplished by pulling a flexible element such as a string wrapped around the periphery of the wheel so that linear motion along the flexible element effects rotary motion of the wheel as the flexible element unwinds from the wheel. The pulling of the flexible element is accomplished by pulling its end in a direction roughly tangential with the wheel, as by the action of walking, biking, or any other means of human transport. The flexible element can be pulled downward by the action of gravity on a weight inside a receptacle connected to the end of the flexible element. Human muscle energy and gravitational energy can effect rotation of the wheel in combination if a person pulls the end of the flexible element while moving downward. This can be done by walking, bicycling, or conducting any other means of human transport down a hill, staircase, or any other physical feature allowing movement that is at least partially downward. One or more humans can also hang with some or all of their weight applied to the end of the flexible element so that the action of gravity on their mass produces the gravitational energy effecting rotation of the wheel.

The rate of rotation of the first rotational element is increased via a gear ratio and delivered to a second rotational element. The second rotational element drives a generator that produces a first electrical output, or a combination of voltage and current. The first electrical output is input to a charge control circuit. The charge control circuit is equipped with the ability to negotiate power levels (voltage and current combinations) with attached electronic devices in accordance with USB fast-charging standards. The voltage and current combination output from the charge control circuit, or the DC electrical output, will depend on the voltage and current combination that the charge control circuit has negotiated with the attached electronic device. The DC electrical output is delivered via a USB interface. This interface can include USB-C, USB-A, a combination of both, or any other USB interface.

### DRAWINGS—FIGURES

FIG. 1 is an exploded perspective view of a crank system.

FIG. 2 is an exploded perspective view of a rotational element attachment system and part of a crank system.

FIG. 3 is an exploded perspective view of a gear ratio and generator, which are prior art.

FIG. 4 is an exploded perspective view of a housing system.

FIG. 5 is a perspective view of a printed circuit board with a charge control circuit, which is prior art.

FIG. 6 is a a perspective view of a printed circuit board with a means of smoothing capacitance.

FIG. 7 is a perspective view of a mounting surface securement apparatus.

FIG. 8 is an exploded perspective view of a generator system.

FIG. 9 is a perspective view of mounted printed circuit boards containing a charge control circuit and a means of smoothing capacitance.

FIG. 10 is a perspective view of a generator system.

FIG. 11 is a perspective view of the generator system connected to the crank system mounted to a horizontal surface.

FIG. 12 is a schematic illustrating the electrical connections among parts of the generator system and an electronic device.

FIG. 13 is an exploded perspective view of the mounted generator system and an electronic device.

FIG. 14 is a perspective view of the mounted generator system wherein the mounting surface is vertical.

FIG. 15 is an exploded perspective view of a wheel system and a rotational element attachment system.

FIG. 16 is a perspective view of the mounted generator system attached to the wheel system operable via a hand grip and flexible element wherein the mounting surface is horizontal.

FIG. 17 is a perspective view of the mounted generator system attached to the wheel system operable via a flexible element attached to a receptacle containing a mass wherein the mounting surface is vertical.

### REFERENCE NUMERALS

| Numeral | Name |
|---|---|
| 20 | Nuts |
| 21 | First Handle Recess |
| 22 | Handle |
| 23 | Handle Through Hole |
| 24 | Spindle |
| 25 | Second Handle Recess |
| 26 | Crank Arm |
| 26A | Crank Keyed Hole |
| 26B | Crank Through Holes |
| 26C | Threaded Hole |
| 28 | Cap |
| 28A | Recess Holes |
| 28B | Cap Through Holes |
| 28C | Cap Wall |
| 29 | Cap Keyed Hole |
| 30 | Collar |
| 30A | Collar Keyed Hole |
| 30B | Collar Threaded Holes |
| 30C | Collar Slot |
| 30D | Collar Through Hole |
| 30E | Collar Recess Hole |
| 30F | Collar Threaded Hole |
| 31 | Shaft |
| 32 | First Rotational Element |
| 34 | Key |
| 36 | Base |
| 38 | Fastener A |
| 40 | Fasteners B |
| 42 | Through Holes |
| 44 | First Electrical Output |
| 47 | Gear Ratio |
| 48 | Gearbox Housing |
| 49 | Flange Through Holes |
| 50 | Generator |
| 51 | Second Rotational Element |
| 52 | Front Closure |
| 53 | Gearbox Flange |
| 54 | Hole Features |
| 56 | Front Through Holes |
| 58 | Base Hole |
| 60 | Tube |
| 62 | Perimeter Threaded Holes |
| 64 | Wide Slot |
| 66 | Recess Pocket |
| 67 | USB Interface |
| 68 | USB-C Slot |
| 70 | USB-A Slot |
| 72 | Rear Closure |
| 74 | Rear Closure Mounting Holes |
| 76 | Rear Through Holes |
| 78 | Charge Control Circuit |
| 79 | Charge Control PCB |
| 80 | First Electrolytic Capacitors |
| 81 | First Ceramic Capacitors |
| 82 | Charge Control Through Holes |
| 84 | USB-C Port |
| 86 | USB-A Port |
| 88 | Electrical Port |
| 89 | DC Electrical Output |
| 94 | Means of Smoothing Capacitance |
| 96 | Second Electrolytic Capacitors |
| 98 | Second Ceramic Capacitors |
| 100 | Mounting Holes |
| 102 | Electrical Interface |
| 108 | Horizontal Mounting Surface |
| 108A | Face |
| 110 | Rubber Pad |
| 111 | First Flange |
| 112 | Bracket Body |
| 113 | Second Flange |
| 114 | First C-CLamp |
| 115 | Second C-Clamp |
| 116 | Bolts |
| 118 | Front Perimeter Screws |
| 120 | Gearbox Nuts |
| 122 | Charge Control Mounting Screws |
| 124 | Hollow Cylindrical Spacers |
| 126 | Capacitance Mounting Screws |
| 128 | Rear Perimeter Screws |
| 130 | Vertical Mounting Surface |
| 132 | Wheel |
| 132A | Wheel Keyed Hole |
| 132B | Wheel Through Holes |
| 133 | Peripheral Securement Feature |
| 134 | First Illustrative Arrow |
| 136 | Second Illustrative Arrow |
| 138 | Third Illustrative Arrow |
| 140 | Fourth Illustrative Arrow |
| 142 | Electronic Device |
| 144 | USB Cable |
| 146 | Second USB-C Plug |
| 148 | First USB-C Plug |
| 149 | Flexible Member Free End |
| 150 | Flexible Member |
| 151 | Hand Grip |
| 152 | Fifth Illustrative Arrow |
| 154 | Sixth Illustrative Arrow |
| 155 | Mass |
| 156 | Receptacle |

### DETAILED DESCRIPTION

### Structure and Function

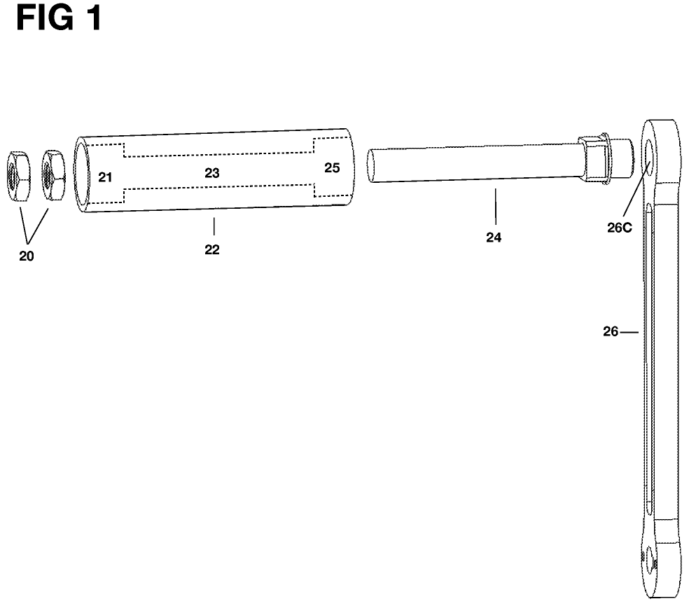

FIG. 1 shows a crank system in perspective exploded view. A handle 22 has a handle through hole 23 that allows it to fit onto a spindle 24. The difference in diameter between handle through hole 23 and spindle 24 is consistent with a clearance fit which allows relative rotational movement between handle 22 and spindle 24. Handle 22 has a first handle recess 21 that allows nuts 20 to recess into the end of handle 22. Spindle 24 has threads that allow for nuts 20 to be screwed onto it, preventing handle 22 from sliding off spindle 24. Tightening the two nuts 20 against each other onto the threads on spindle 24 prevents their self-loosening and their being tightened against handle 22 in a way that would prevent relative rotational movement between handle 22 and spindle 24. Spindle 24 has threads that allow it to be screwed into a corresponding threaded hole 26C on a crank arm 26. The side of spindle 24 closest to crank handle 26 recesses into second handle recess 25.

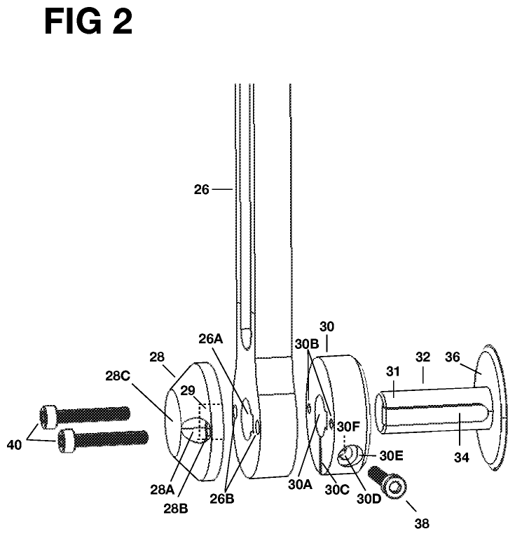

FIG. 2 shows part of the crank system and a rotational element attachment system in perspective exploded view. A first rotational element 32 is comprised of a shaft 31 and a key 34. A collar 30 has a collar keyed hole 30A. The dimensions of the cross section of collar keyed hole 30A when viewed on the radial plane with shaft 31 is such that it is the same shape but slightly larger than shaft 31 and key 34. This allows collar 30 to slide onto shaft 31 and key 34. Collar 30 is positioned onto shaft 31 and key 34 such that there is sufficient clearance between a base 36 and collar 30 to allow for unobstructed rotational movement of collar 30 relative to base 36. Collar 30 includes a collar slot 30C that creates an opening between collar keyed hole 30A and the outer perimeter of collar 30. Collar slot 30C has a rectangular cross section when viewed on the radial plane with shaft 31 and extends along the entire axial length of collar 30. A collar through hole 30D oriented along the same axis as a fastener A 38 has a diameter allowing a clearance fit between it and fastener A 38. It extends only to collar slot 30C. A collar threaded hole 30F oriented along the same axis as fastener A 38 then extends from collar slot 30C to the perimeter of collar 30 opposite the head of fastener A 38. A collar recess hole 30E with a diameter slightly larger than the head of a fastener A 38 is oriented along the same axis as collar through hole 30D and extends to a depth allowing the head of fastener A 38 to recess partially into the side of collar 30. When fastener A 38 is inserted into collar through hole 30D, it spans the distance of collar slot 30C and engages the the threads in collar threaded hole 30F on the other side. As the fastener A 38 is tightened, its head touches the bottom of collar recess hole 30E and results in a clamping force securing collar 30 onto shaft 31 and key 34. Some collar threaded holes 30B extend along the majority of the axial length of collar 30. Crank arm 26 has a crank keyed hole 26A that allows it to slide onto shaft 31 and key 34 until crank arm 26 is touching collar 30. A cap keyed hole 29 in a cap 28 is similar in cross sectional geometry to collar keyed hole 30A, but it extends only partially along the axial length of cap 28, leaving a cap wall 28C that prevents cap 28 from sliding onto shaft 31 beyond the axial depth of cap keyed hole 29. A pair of cap through holes, one of which is labeled 28B, have the same diameter and axial orientation as a pair of crank through holes 26B, allow fasteners B 40 to pass through cap 28 and crank arm 26 to engage the threads in collar threaded holes 30B on collar 30. Recess holes oriented along the axes of fasteners B 40 extend to a partial depth along this axis into cap 28. One of these recess holes is labeled 28A. As fasteners B 40 are tightened, the bottoms of their heads make contact with recess holes 28A. This results in a clamping force holding cap 28, crank arm 26, and collar 30 together.

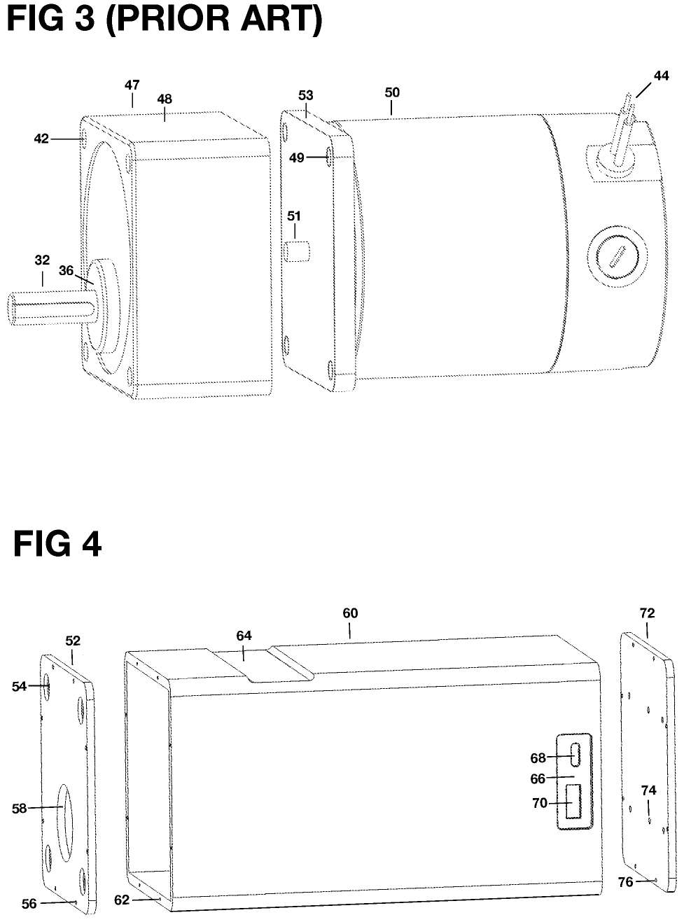

FIG. 3 shows a gear ratio and a generator. Gear ratios and generators are prior art. A gear ratio 47 is mechanically coupled to a generator 50 via a second rotational element 51. Gear ratio 47 is comprised of a gearbox housing 48 containing gears that increase the number of rotations per unit time of a second rotational element 51 relative to first rotational element 32. Four through holes, one of which is labeled 42, extend for the entire axial length of gearbox housing 48. A gearbox flange 53 is attached to generator 50 and has four flange through holes, one of which is labeled 49, of the same geometry and axial orientation as through holes 42. Gear ratio 47 has a 30:1 gear reduction ratio such that the rotational speed of second rotational element 51 is greater than the rotational speed of first rotational element 32 by a factor of 30. Generator 50 is a 24 volt DC motor designed for operation at 1800 RPM with a rated continuous mechanical output power of 40 watts. Generator 50 converts mechanical input power resulting from the rotation of second rotational element 51 to electrical power at first electrical output 44.

FIG. 4 shows a housing system. A front closure 52 has four hole features at each of its corners, one of which is indicated as 54. Hole features 54 consist of a through hole extending across the entire thickness of front closure 52 and a larger recess hole extending for only part of the thickness of front closure 52. Abase hole 58 extends across the full thickness of front closure 52. Eight front through holes through front closure 52, one of which is labeled 56, extend across the full thickness of front closure 52. A tube 60 incorporates a wide slot 64. Eight perimeter threaded holes, one of which is labeled 62, are axially aligned with front through holes 56 and extend to a depth into the tube representing at least two multiples of the thickness of front closure 52. A USB-C slot 68 allows a male USB-C plug connector to pass without obstruction through to the interior of tube 60. A USB-A slot 70 is cut such that it allows a male USB-A plug connector to pass without obstruction through to the interior of tube 60. A rectangular recess pocket 66 creates a surface against which the non-charge plug portion of male USB-C and USB-A plugs inserted into USB-C slot 68 and USB-A slot 70 can make contact, ensuring that the plugs are not inserted too far. The depth of recess pocket 66 allows a sufficient portion of USB-C and USB-A plug connectors to protrude into the interior of tube 60 via USB-C slot 68 and USB-A slot 70 to completely insert into female USB-C and USB-A plugs installed adjacent to the interior wall of tube 60. A rear closure 72 has six threaded rear closure mounting holes extending along a portion of the thickness of rear closure 72, one of which is labeled 74. Eight rear through holes, one of which is labeled 76, extend through the thickness of rear closure 72. The pattern of rear through holes 76 is the same as that of front through holes 56. Threaded holes of the same pattern extend into tube 60 from its side closest to the rear closure 72 to a depth of at least two multiples of the thickness of rear closure 72.

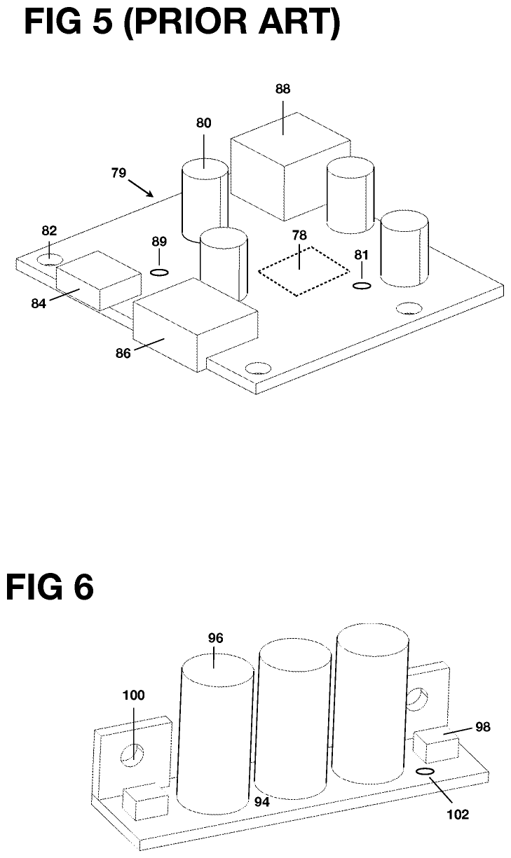

FIG. 5 is a simplified depiction of a charge control printed circuit board (PCB), which is prior art, in perspective view. The charge control PCB 79 depicted in FIG. 5 is manufactured by Coolgear Inc. and has model number WTF-CG69. It supports a charge output power of 60 W. Charge control PCB 79 has several integrated chips installed on it, including a buck-boost controller chip and a chip that manages the negotiation of power levels between an upstream power source, typically a 12V car outlet or DC power supply, and a downstream power sink, typically a fast-charging-compatible electronic device such as a mobile phone, tablet, drone, camera, or laptop. Together these integrated chips and associated circuitry constitute a charge control circuit 78. These devices connect to the charge control PCB via a USB cable connected to a USB-C port 84 or USB-A port 86. USB-C port 84 offers USB Power Delivery, in addition to other standards, and would typically connect to devices operating according to the USB Power Delivery standard, while USB-A port 86 offers various fast-charging standards and would typically connect to devices compatible with Qualcomm Quick Charge, such as Android-based mobile phones, or Apple devices charging at up to 5 volts, 2.4 amps. An electrical port 88 is designed to electrically couple to first electrical output 44. Several first electrolytic capacitors, one of which is labeled 80, as well as some first ceramic capacitors 81, are connected to both the electrical port 88 and a DC electrical output 89 of the charge control PCB 79. DC electrical output 89 is mechanically and electrically connected to USB-C port 84 and USB-A port 86. Four charge control through holes, one of which is labeled 82, allow charge control PCB 79 to be securely mounted.

FIG. 6 shows a simplified depiction of a means of smoothing capacitance 94 in perspective view. It consists of three 1000 uF second electrolytic capacitors connected in parallel, one of which is labeled 96, as well as two ceramic 25 uF second ceramic capacitors, one of which is labeled 98, connected in parallel to one another and to second electrolytic capacitors 96. Two mounting holes, one of which is labeled 100, allow the means of smoothing capacitance 94 to be securely mounted. An electrical interface 102 of the means of smoothing capacitance 94 allows parallel electrical connection to first electrical output 44.

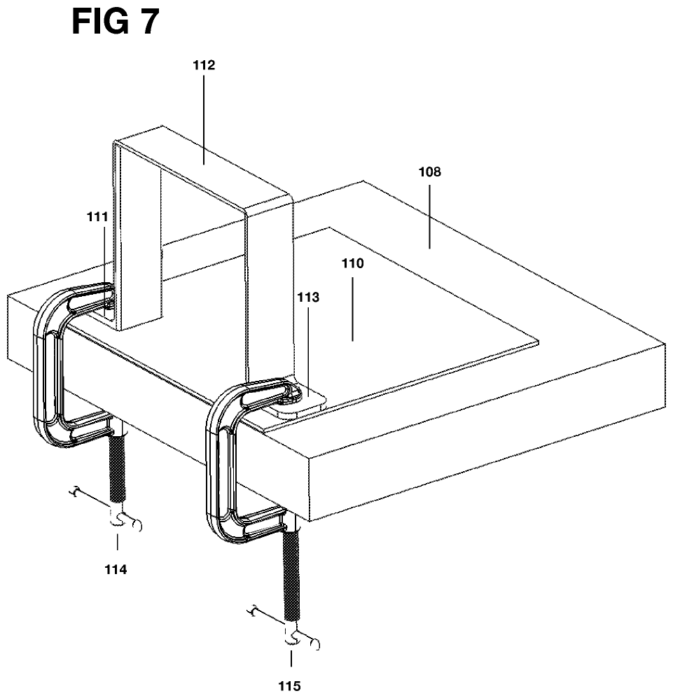

FIG. 7 shows a mounting surface securement apparatus. A horizontal mounting surface 108, such as a table or counter, has a non-slip rubber pad 110 placed on it. On top of rubber pad 110 is a bracket body 112 with a first flange 111 and a second flange 113. A first c-clamp 114 is placed such that it contacts a first flange 111. A second c-clamp 115 is placed such that it contacts a second flange 113. As first c-clamp 114 and second c-clamp 115 are tightened, they clamp bracket body 112 to rubber pad 110 and horizontal mounting surface 108.

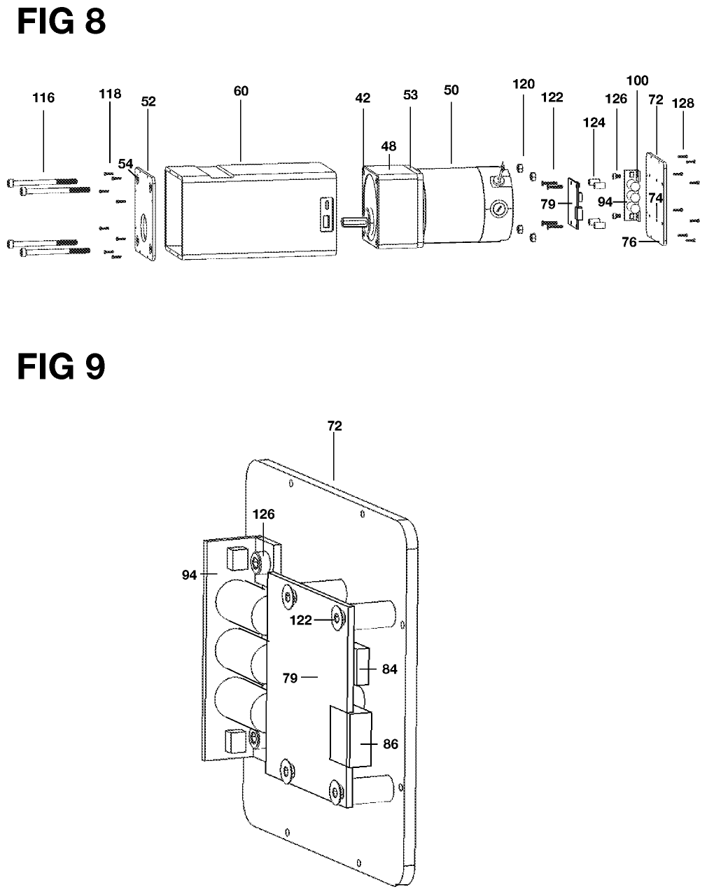

FIG. 8 shows a generator system, including the interaction of generator 50, gear ratio 47, the housing system of FIG. 4, the charge control PCB of FIG. 5, and the means of smoothing capacitance 94 of FIG. 6. Bolts 116 extend through hole features 54 on front closure 52, through holes 42 on gearbox housing 48, through holes 49 on flange 53, and into gearbox nuts 120. Gearbox nuts 120 adjoin gearbox flange 53 while the bottom surface of the head of bolts 116 adjoin the bottom surface of the recess portion of hole features 54 on front closure 52. In this way bolts 116 tightened into gearbox nuts 120 secure front closure 52 to gearbox housing 48, which in turn secures generator 50 to gearbox housing 48. Front perimeter screws 118 extend through front through holes 56 and into perimeter threaded holes 62. In this way front closure 52 is secured to tube 60 via the tightening of front perimeter screws 118 into perimeter threaded holes 62. A set of charge control mounting screws 122 extends through charge control through holes 82, a set of hollow cylindrical spacers 124, and into rear closure mounting holes 74. In this way the tightening of charge control mounting screws 122 into rear through holes 76 secures charge control PCB 79 to rear closure 72. Hollow cylindrical spacers 124 ensure that a gap is maintained between charge control PCB 79 and rear closure 72. A pair of capacitance mounting screws 126 extends through mounting holes 100 on means of smoothing capacitance 94 and into rear closure mounting holes 74. In this way the tightening of capacitance mounting screws 126 into rear closure mounting holes 74 secures means of smoothing capacitance 94 to rear closure 72. A set of rear perimeter screws 128 extend through rear through holes 76 and into threaded perimeter holes in tube 60 of a similar pattern and alignment to perimeter threaded holes 62. In this way the tightening of rear perimeter screws 128 into threaded perimeter holes on tube 60 secures rear closure 72 to tube 60.

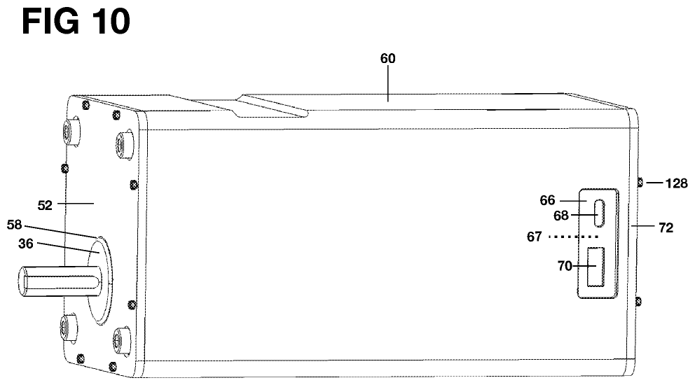

FIG. 9 shows charge control PCB 79 and means of smoothing capacitance 94 mounted to rear closure 72 via charge control mounting screws 122, one of which is labeled, and capacitance mounting screws 126, one of which is labeled.

FIG. 10 shows the generator system of FIG. 8 fully assembled including fasteners. Base 36 protrudes through base hole 58. Rear closure 72 has mounted to it charge control PCB 79 and means of smoothing capacitance 94 as pictured in FIG. 9. When rear closure 72 is secured onto tube 60 with rear perimeter screws 128, one of which is labeled, USB-A port 86 (FIG. 9) aligns with USB-A slot 70 such that a male USB-A charge connector is able to fully insert into USB-A port 86 (FIG. 9). When rear closure 72 is secured onto tube 60 with rear perimeter screws 128, USB-C port 84 (FIG. 9) aligns with USB-C slot 68 such that a male USB-C charge connector is able to fully insert into USB-C port 84 (FIG. 9). Together USB-A port 86 and USB-C port 84 constitute a USB interface 67.

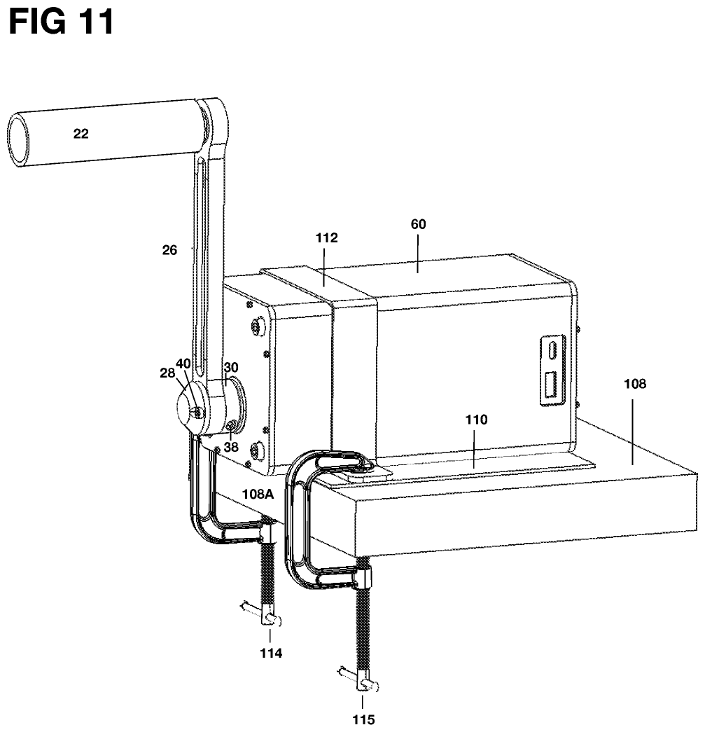

FIG. 11 shows in perspective view a mounted generator system wherein the mounting surface is horizontal and the crank system of FIG. 1 is attached. Bracket body 112 fits into wide slot 64 on tube 60 pictured in FIG. 4. When first c-clamp 114 and second c-clamp 115 are tightened, tube 60 is secured to horizontal mounting surface 108. The placement of tube 60 relative to horizontal mounting surface 108 is such that the distance between the plane of crank arm 26 closest to a face 108A of horizontal mounting surface 108 and orthogonal to it is greater than the maximum orthogonal protrusion of first c-clamp 114 and second c-clamp 115 relative to face 108A. This allows the crank system to rotate freely as it rotates about the axis of shaft 31. Tightened fasteners B 40 secure cap 28 to crank arm 26 and collar 30, which in turn is secured to shaft 31 and key 34 (FIG. 3) by tightened fastener A 38.

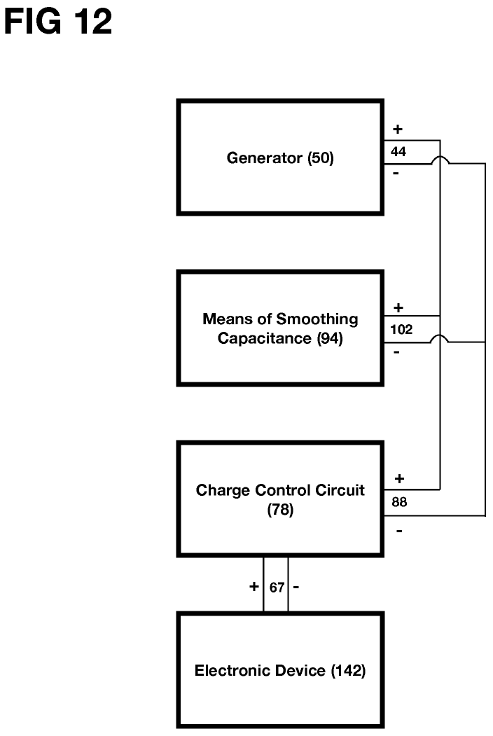

FIG. 12 illustrates the electrical connections between generator 50, means of smoothing capacitance 94, charge control PCB 79, and an electronic device 142. The first electrical output 44 is connected in series to electrical port 88. First electrical output 44 is connected in parallel to electrical interface 102. USB interface 67 is capable of connecting in series to electronic device 142 via a USB cable.

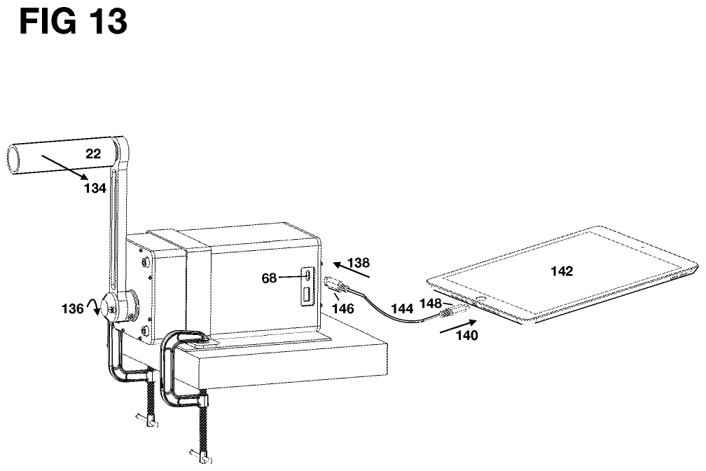

FIG. 13 illustrates the mounted generator system connected to the crank system wherein the mounting surface is horizontal connecting to an electronic device. A USB cable 144 connects on one end to electronic device 142 by pushing a first USB-C plug 148 into electronic device 142 in the direction of a fourth illustrative arrow 140. USB cable 144 connects to the generator system by pushing a second USB-C plug 146 through USB-C slot 68 in the direction of a third illustrative arrow 138, on the other side of which is USB-C port 84 as indicated in FIG. 5 and FIG. 9.

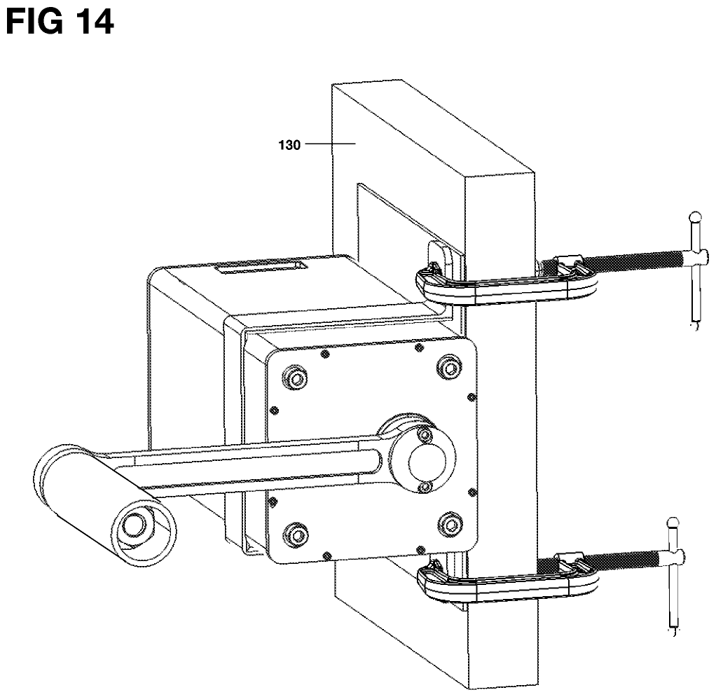

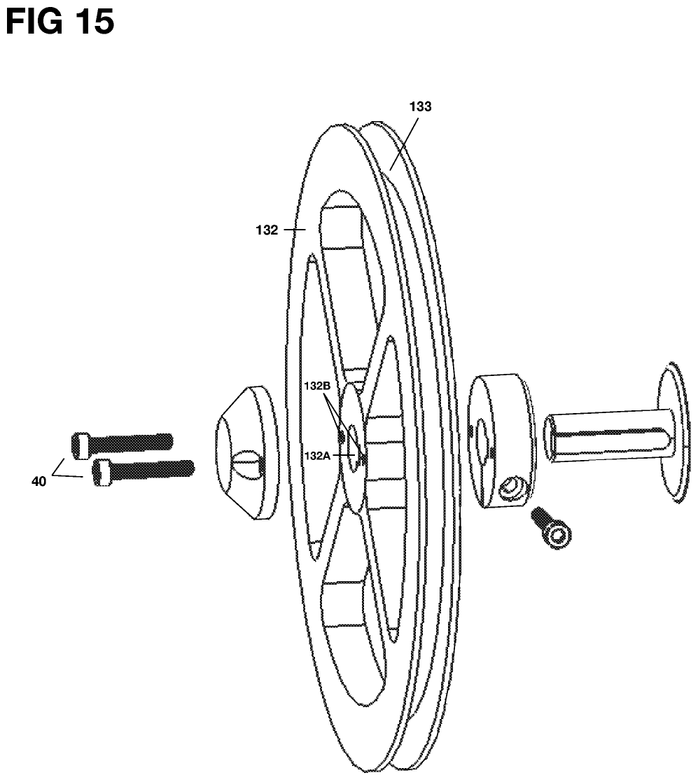

FIG. 14 illustrates the mounted generator system connected to the crank system of FIG. 1 wherein the mounting surface is a vertical mounting surface 130 such as a door.

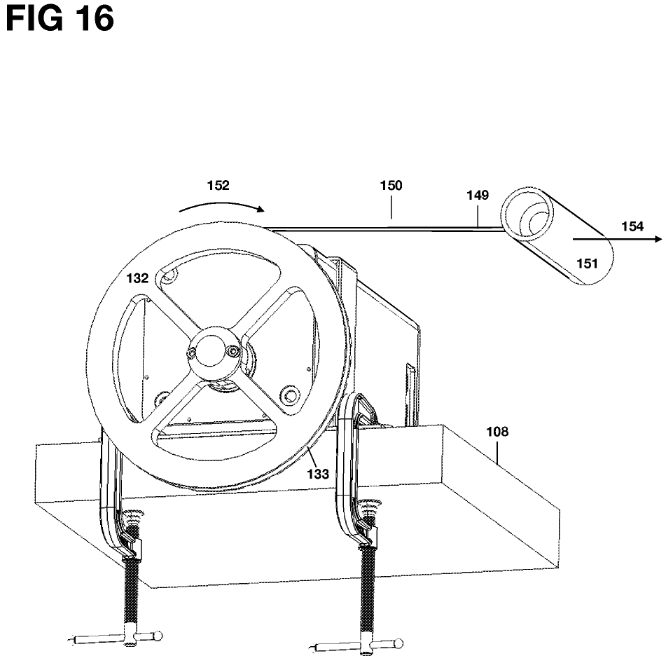

FIG. 15 illustrates a wheel system. Wheel 132 uses the same rotational element securement system depicted in FIG. 2, including a wheel keyed hole 132A and wheel through holes 132B identical to crank keyed hole 26A and crank through holes 26B on crank arm 26 shown in FIG. 2. This makes wheel 132 interchangeable with crank arm 26 by loosening and removing fasteners B 40, removing crank arm 26, installing wheel 132 in its place, and reinserting and tightening fasteners B 40, allowing the user to select and install which drive system best suits their preferences or conditions. Wheel 132 includes a peripheral securement feature 133.

FIG. 16 illustrates the mounted generator system connected to the wheel system of FIG. 15 wherein the mounting surface is horizontal surface 108. A flexible member 150 encircles wheel 132 within peripheral securement feature 133 multiple times. Hand grip 151 attaches to a flexible member free end 149 of flexible member 150.

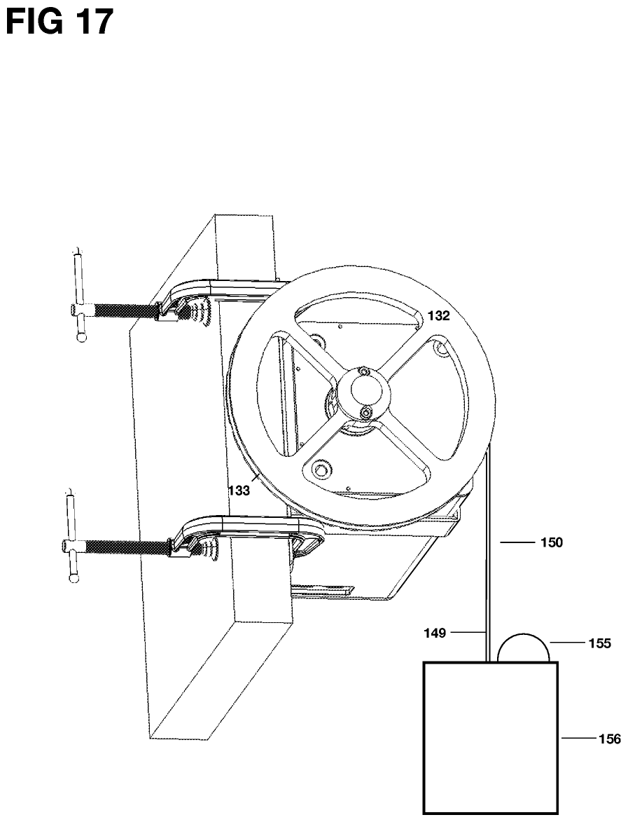

FIG. 17 illustrates the generator system connected to the wheel system of FIG. 15 and mounted to a vertical surface 130. A receptacle 156 into which is placed a mass 155 attaches to flexible member free end 149 of flexible member 150.

### Operation of Embodiments

A first embodiment illustrated in FIG. 11 and FIG. 13, as well as a second embodiment illustrated in FIG. 14, operates via muscle energy applied to handle 22 in the direction of a first illustrative arrow 134. This results in rotational energy comprised of rotational velocity and torque at rotational element 32 in the direction indicated by a second illustrative arrow 136. The torque and rotational velocity of first rotational element 32 are in turn imparted to second rotational element 51 but are modified according to gear ratio 47. The rotational energy of second rotational element 51 (FIG. 3) generates a voltage and current via generator 50 that charges the connected electronic device 142 (FIG. 12). If the user maintains a rotational speed greater than 60 RPM, the device will charge continuously.

A third embodiment illustrated in FIG. 16 operates via muscle energy applied to hand grip 151 in the direction of sixth illustrative arrow 154. When hand grip 151 is pulled in the direction of a sixth illustrative arrow 154 tangential to the perimeter of wheel 132, that linear movement and energy is converted to rotational movement in the direction of a fifth illustrative arrow 152 and energy, which results in first rotational element 32 (FIG. 3) rotating and providing the mechanical torque and velocity to charge an electronic device at USB fast-charging speeds. Once the flexible element entirely unwinds from wheel 132 and rotation of wheel 132 ceases, the flexible element can be rewound circumferentially about wheel 132 within peripheral securement feature 133 multiple times and the process repeated. This results in rotation of wheel 132 in the direction of fifth illustrative arrow 152.

A fourth embodiment illustrated in FIG. 17 operates via the conversion of gravitational potential energy associated with mass 155 inside receptacle 156 to kinetic energy. When allowed to drop, receptacle 156 and mass 155 pull downward by the action of gravity in a direction tangential to wheel 132 and produce rotational energy. This results in rotation of wheel 132 in the direction of fifth illustrative arrow 152 (FIG. 16) and provision of the mechanical torque and velocity to charge an electronic device at USB fast-charging speeds.

### Additional Embodiments

Additional embodiments result from combining the third and fourth embodiments. Any linear movement tangential to wheel 132 converts linear motion to rotational input energy that the generator system can convert to electrical power for the purpose of fast-charging electronic devices. Flexible member free end 149 (FIG. 16) can be attached to anything capable of performing work in a linear direction. For example, a user could grasp hand grip 151 and walk or run in a direction tangential to wheel 132, connect the end of the flexible element to a belt or harness and walk or run in a direction tangential to wheel 132, or attach flexible member free end 149 to the seat post of a bicycle and ride in a direction tangential to wheel 132. If the direction of linear movement is downward or partially downward, such as if the generator system with the wheel system mounted on a horizontal surface is at the top of a hill, a user will benefit from the gravitational potential energy resulting from their change of elevation combined with the muscle energy associated with their movement such as via bicycling, walking, or running. This resulting combination of muscle energy and gravitational potential energy will then be converted into electrical power that can fast-charge electronic devices.

Additional embodiments result from mass 155 being provided by various objects, such as water, stones, or any other massive objects or combinations of massive objects that can be placed in receptacle 156. Mass 155 could also be part or all of a human's body weight. If the generator system with the wheel system mounted on a horizontal or vertical surface is on an elevated ledge, for example, and a person steps off the ledge and into the receptacle, gravity acting on their mass would become the energy source for producing electrical power that can fast-charge electronic devices. If the ledge is positioned at the top of a staircase, such as the kind found inside a multi-story dwelling, outside an office building, or leading up to a patio, a person could repetitively ascend the steps, step off the ledge into the receptacle to descend in order to provide electrical power to charge their device, re-ascend the steps, rewind flexible element 150 onto wheel 132, step into the receptacle to descend in order to provide electrical power to charge their device, and so on.

Additional embodiments result from varying the mounting angle of the generator system. In addition to horizontal mounting surface 108 oriented at zero degrees with the horizon, and vertical mounting surface 130 oriented at 90 degrees with the horizon, any mounting surface angle between zero and 360 degrees with the horizon (where angles between 180 and 360 degrees would represent orientations with the mounting surface situated above the generator system) is possible, such as a slanted rooftop or ceiling.

Additional embodiments result from means of smoothing capacitance 94 being removed from all embodiments previously described. In its place a buck controller can be used to limit the voltage of the first electrical output to levels appropriate to charge control circuit 78.

Additional embodiments result from charge control circuit 78 being incorporated via means other than charge control PCB 79. PCB 79 could be modified to allow charge control circuit 78 to deliver higher power output and faster charging speeds as allowed by USB fast-charging standards.

Additional embodiments result from varying the operational values of gear ratio 47 and generator 50. For example, it is possible to use a gear ratio greater than or less than 30:1 or a motor with rated power less than or greater than 40 W watts, rated voltage of less or greater than 24V, or operating speed less or more than 1800 RPM.

Additional embodiments result from first rotational element 32 being comprised of something other than shaft 31 and key 34. Examples of rotational elements that fulfill the function of transferring to a generator rotational energy that can fast-charge a device via USB in the same manner as shaft 31 and key 34 include gears, sprockets, splined shafts, splined hollow cylinders, and belt-driven wheels.

Additional embodiments result from gear ratio 47 being provided by a means other than gears, such as differentially sized wheels or sprockets driven by belts or chains.

### CONCLUSION

The portable electricity generator herein described is able to deliver many times more charge power to electronic devices charged via USB than the prior art. It does this by incorporating power electronics allowing it to operate in accordance with USB fast-charging standards. While hand-cranked portable electricity generators described in the prior art require two-handed operation, all embodiments of the portable electricity generator herein described that involve hand cranking allow for one-handed operation. While no portable electricity generators able to charge electronic devices via USB in the prior art are powered by gravitational potential energy, several embodiments of the portable electricity generator herein described are powered by gravitational potential energy. While no electricity generators able to charge electronic devices via USB described in the prior art can combine energy sources, embodiments of the portable electricity generator described herein can operate on a combination of human muscle energy and gravitational potential energy.

What is claimed is:

1. A machine comprising
a first rotational element in communication with a second rotational element via a gear ratio to increase the number of rotations per unit time of said second rotational element relative to the rotations per unit time of said first rotational element;
a generator producing a first electrical output from mechanical rotation of said second rotational element;
a charge control circuit for converting said first electrical output to a DC electrical output in accordance with at least one USB fast-charging standard such as USB Power Delivery or Qualcomm Quick Charge;
a USB interface, said USB interface being mechanically and electrically connected to said charge control circuit, and allowing a user to mechanically and electrically connect to a USB cable provided by said user, said USB cable being mechanically and electrically connected to an electronic device provided by said user.

2. The machine of claim 1 wherein a means of smoothing capacitance is applied to said first electrical output.

3. The machine of claim 1 further comprising a crank arm mechanically coupled to said first rotational element, said first rotational element rotating when said crank arm is rotated.

4. The machine of claim 3 wherein said crank arm is mechanically coupled to a crank handle.

5. The machine of claim 1 further comprising a wheel wherein said wheel is mechanically coupled to said first rotational element so that said first rotational element rotates when said wheel is rotated.

6. The machine of claim 5 wherein said wheel includes a peripheral securement feature for the reception of a flexible member that sits within and is secured by said peripheral securement feature.

7. The machine of claim 6 wherein said flexible member is mechanically coupled to said peripheral securement feature, said flexible member being repetitively wrapped around the periphery of said wheel, said peripheral securement feature preventing said flexible member from unraveling, a flexible member free end effecting rotation of said wheel when moved tangentially relative to said wheel as said flexible member unwinds from said wheel.

8. The machine of claim 7 wherein said flexible member free end is mechanically coupled to a hand grip.

9. The machine of claim 7 wherein said flexible member free end is mechanically coupled to a receptacle into which a mass can be removably placed.

10. The machine of claim 1 wherein a collar is mechanically coupled to said first rotational element, said collar being capable of being removably mechanically coupled to said crank arm, said wheel, or any other attachment whose rotation effects rotation of said first rotational element.

11. An apparatus for removably securing said generator to a mounting surface, said apparatus comprising
a bracket body adapted to extend at least partially around said generator, said bracket body attached to a first flange and a second flange that sit parallel to said mounting surface;
a first c-clamp and a second c-clamp contacting said flanges and clamping them to said mounting surface when tightened.

12. The apparatus of claim 11, further comprising a rubber pad for enhancing adhesion and preventing damage to said mounting surface, said rubber pad being placed on said mounting surface, said bracket and said rigid structure being placed on said rubber pad.
